(19) United States
(12) Patent Application Publication
(10) Pub. No.: US 2025/0272778 A1
(43) Pub. Date: Aug. 28, 2025

(54) MULTI-LAYER READING METHOD, DIRECT MEMORY ACCESS MODULE, PROCESSOR AND DEVICE

(71) Applicants: VERISILICON MICROELECTRONICS (CHENGDU) CO., LTD., Sichuan (CN); VERISILICON MICROELECTRONICS (SHANGHAI) CO., LTD., Shanghai (CN); VERISILICON TECHNOLOGY (SHANGHAI) CO., LTD., Shanghai (CN); VERISILICON MICROELECTRONICS (NANJING) CO., LTD., Nanjing (CN); VERISILICON MICROELECTRONICS (HAINAN) CO., LTD., Hainan (CN)

(72) Inventors: Xinghong HE, Sichuan (CN); Jia LI, Sichuan (CN); Hanqi ZENG, Sichuan (CN); Mingpeng YANG, Sichuan (CN); Ting YE, Sichuan (CN)

(21) Appl. No.: 18/927,729

(22) Filed: Oct. 25, 2024

(30) Foreign Application Priority Data
Feb. 27, 2024 (CN) 2024102164584

(51) Int. Cl. G06T 1/60; G06T 7/11

(52) U.S. Cl. CPC G06T 1/60; G06T 7/11

(57) ABSTRACT

A multi-layer reading method, a direct memory access module, a processor and a device are provided. The method includes: determining, in a case where multiple to-be-read layers overlap in a specified direction of a display screen, a sequential order of reading image blocks in the multiple layers, wherein the image blocks are determined according to upper and lower boundaries of the multiple layers on the display screen; and reading each image block according to the sequential order of reading the image blocks.

### CROSS REFERENCE TO RELATED APPLICATIONS

The present disclosure claims priority to the Chinese patent application with the filing No. 2024102164584 filed with the China National Intellectual Property Administration on Feb. 27, 2024, and entitled “MULTI-LAYER READING METHOD, DIRECT MEMORY ACCESS MODULE, PROCESSOR AND DEVICE”, contents of which are incorporated herein by reference in their entirety.

### TECHNICAL FIELD

The present disclosure relates to the field of image processing, and specifically to a multi-layer reading method, a direct memory access module, a processor and a device.

### BACKGROUND ART

DPU (Display process unit) is an application specific processor responsible for image processing in an SOC (System on Chip) system. In DPU, a functional module responsible for retrieving layers from a storage module is a DMA (Direct Memory Access) module.

In the prior art, since DPU demands real-time performance during display, and DPU requires an on-screen display order to be strictly from top to bottom and from left to right, when DMA takes data from the storage module, it must determine an order of displayed pictures on the screen so as to determine an order of getting data. In this case, if images overlap in a Y direction, DMA must cyclically jump between addresses of two ROIs (regions of interest) according to the display order. Exemplarily, as shown in FIG. 1, FIG. 1 shows a schematic diagram of two images overlapping in the Y direction. FIG. 1 shows two image regions roi0 and roi1, which overlap in the Y direction. When an upper non-overlapping region is displayed on the screen, a reading order of DMA is as shown by a reading order 110, and DMA only needs to read data in the display order. But when overlapping regions are displayed, the reading order of DMA is as shown by a reading order 120. Implementation logic of the reading order 120 is relatively complex, for example, it needs to judge when to start reading the region roi0 and when to start reading roi1, or DMA needs to judge each time it sends a read address request. In order to complete a jump function, DMA puts in a very large area and a lot of power.

Moreover, as judgment logic results in a long reading time of DMA, in order to ensure real-time data display, the prior art usually restricts one DMA to read only 1-2 image regions.

### SUMMARY

In view of this, the present disclosure aims at providing a multi-layer reading method, a direct memory access module, a processor and a device, so as to overcome the shortcoming in the prior art that boundary judgement must be performed when reading multiple layers.

In the first aspect, embodiments of the present disclosure provide a multi-layer reading method, wherein the method includes: determining, in a case where multiple to-be-read layers overlap in a specified direction of a display screen, a sequential order of reading image blocks in the multiple layers, wherein the image blocks are determined according to upper and lower boundaries of the multiple layers on the display screen; and reading the image blocks according to the sequential order of reading the image blocks.

In the above multi-layer reading method, the sequential order of reading the image blocks is determined before reading, and the image blocks are directly read one by one according to the order of reading the image blocks, without judging layer boundaries in each time of reading, thus getting rid of the complex boundary judgment logic, reducing the steps in the reading, and improving the reading efficiency.

In an optional embodiment of the present disclosure, the method further includes: acquiring storage information and display information of the multiple layers, wherein the storage information includes base addresses and data lengths of the layers, and the display information includes display positions and display directions; and determining whether the multiple layers overlap in the specified direction, according to the storage information and the display information.

In the above embodiment, whether the multiple layers overlap in the specified direction can be judged quickly and accurately through the storage information and the display information of the multiple layers.

In an optional embodiment of the present disclosure, the method further includes: simulating a display state of the multiple layers on the display screen; and simulating extension of the upper and lower boundaries of each layer in a target direction, to simulate segmentation of the multiple layers into multiple image blocks, wherein the target direction is a direction perpendicular to the specified direction.

In the above embodiment, by simulating the display state of the multiple layers on the display screen and simulating the extension of the upper boundaries and the lower boundaries of the layers in the target direction, the multiple layers are simulated to be segmented into multiple image blocks simply and quickly.

In an optional embodiment of the present disclosure, determining a sequential order of reading image blocks in the multiple layers includes: determining the sequential order of reading the image blocks according to positions of the image blocks on the display screen and an overlapping relation in the specified direction.

In the above embodiment, through the positions of the image blocks on the display screen and the overlapping relation in the specified direction, the sequential order of the direct memory access module reading the image blocks can be accurately determined, thus there is no need to perform layer boundary judgment in each time of reading, getting rid of the complex boundary determination logic, reducing the steps in the reading process, and improving the reading efficiency.

In an optional embodiment of the present disclosure, the determining the sequential order of reading the image blocks according to positions of the image blocks on the display screen and an overlapping relation in the specified direction includes: mapping each image block to a grid coordinate system according to the position of each image block on the display screen and the overlapping relation in the specified direction, wherein grid coordinate sizes in the grid coordinate system characterize the sequential order of reading the image blocks; calculating basic coordinates of each image block in the display screen; calculating the base address of each image block in the storage module according to the basic coordinates of each image block; and associating grids in the grid coordinate system with the base addresses of the image blocks so as to obtain grid distribution, wherein the grid distribution is used to determine the sequential order of reading the image blocks.

In the above embodiment, by mapping each image block in the grid coordinate system, and associating the grids in the grid coordinate system with the base addresses of the image blocks so as to obtain the grid distribution, the direct memory access module subsequently can directly read data according to the grid distribution, thus improving the reading efficiency. In an optional embodiment of the present disclosure, the reading each of the image blocks according to the sequential order of reading the image blocks includes: sequentially selecting the grid rows in the grid distribution according to an ascending order of row values in the grid distribution, and reading image blocks corresponding to all grid columns in each selected grid row.

In the above embodiment, the grid distribution indicates the sequential order of reading the image blocks, and the data read by the direct memory access module according to the grid distribution meets display requirements. Moreover, the grids in each row contain all image blocks overlapping in a specified region, and the direct memory access module does not need to jump and judge between different layers in the grids of the same row, thus improving the reading efficiency, and reducing the reading time.

In an optional embodiment of the present disclosure, the sequentially selecting the grid rows in the grid distribution according to an ascending order of row values in the grid distribution and reading image blocks corresponding to all grid columns in each selected grid row includes: repeatedly executing a reading step until all image blocks corresponding to the grids in the grid distribution are read, wherein the reading step includes: acquiring a current count value of a counter; selecting one row of grids in the grid distribution according to the current count value, so as to obtain a current grid row; performing data reading according to the base addresses corresponding to each column of grids in the current grid row; and updating the count value of the counter if the number of columns of the current grid row is equal to the number of layers, wherein the updated count value is used to determine a next grid row.

In the above embodiment, the layer reading performed through the grid distribution gets rid of the complex boundary determination logic, simplifies the address calculation, and simplifies the reading steps and circuit design, and addition of layers no longer causes exponential increase of logic complexity of circuit, which becomes linear increasing.

In the second aspect, embodiments of the present disclosure provide a direct memory access module, including: a planning unit, configured to determine, in a case where multiple to-be-read layers overlap in a specified direction of a display screen, a sequential order of reading image blocks in the multiple layers, wherein the image blocks are determined according to upper and lower boundaries of the multiple layers on the display screen; and a reading unit, configured to read each of the image blocks according to the sequential order of reading the image blocks.

In an optional embodiment of the present disclosure, the planning unit is further configured to: simulate a display state of the multiple layers on the display screen; and simulate extension of the upper and lower boundaries of each layer in a target direction, to simulate segmentation of the multiple layers into multiple image blocks, wherein the target direction is a direction perpendicular to the specified direction.

In an optional embodiment of the present disclosure, the planning unit is specifically configured to: determine the sequential order of reading the image blocks according to positions of the image blocks on the display screen and an overlapping relation in the specified direction.

In an optional embodiment of the present disclosure, the planning unit is specifically configured to: map each image block to a grid coordinate system according to the position of each image block on the display screen and the overlapping relation in the specified direction, wherein grid coordinate sizes in the grid coordinate system characterize the sequential order of reading the image blocks; calculate basic coordinates of each image block in the display screen; calculate base addresses of each image block in a storage module according to the basic coordinates of each image block; and associate grids in the grid coordinate system with the base addresses of the image blocks so as to obtain grid distribution, wherein the grid distribution is used to determine the sequential order of reading the image blocks.

In the third aspect, embodiments of the present disclosure provide a display processor, wherein the display processor includes: a processing layer and the direct memory access module according to any one of the second aspect; and the processing layer is configured to receive and process data read by the direct memory access module.

In the fourth aspect, embodiments of the present disclosure provide an electronic device, wherein the electronic device includes: a display screen and the display processor according to the third aspect, and the display screen is connected to the display processor.

In the fifth aspect, embodiments of the present disclosure provide an electronic device, wherein the electronic device includes a memory and a processor, and wherein the memory is configured to store computer programs, and the computer programs include program instructions; and the processor is configured to call the computer programs, so as to implement the multi-layer reading method according to any one of the first aspect.

Other features and advantages of the present disclosure will be illustrated in the following description. Objectives and other advantages of the present disclosure may be implemented and obtained through structures specifically indicated in the description and drawings.

### BRIEF DESCRIPTION OF DRAWINGS

In order to more clearly illustrate the technical solutions in the embodiments of the present disclosure or in the prior art, drawings that need to be used in the embodiments will be introduced below. Apparently, the drawings in the following description merely show some embodiments of the present disclosure. Those ordinarily skilled in the art also could obtain other drawings in light of these drawings without using inventive efforts. With these drawings, the above and other objectives, features and advantages of the present disclosure will be clearer.

FIG. 1 is a schematic diagram of two images overlapping in a Y direction in the prior art;

FIG. 2 is a flowchart of a multi-layer reading method provided in embodiments of the present disclosure;

FIG. 3 is a schematic diagram of a display state of multiple layers provided in embodiments of the present disclosure;

FIG. 4 is a schematic diagram of another display state of multiple layers provided in embodiments of the present disclosure;

FIG. 5 is a schematic diagram of image blocks provided in embodiments of the present disclosure;

FIG. 6 is a schematic diagram of image block ordering provided in embodiments of the present disclosure;

FIG. 7A is a schematic diagram of a grid coordinate system provided in embodiments of the present disclosure;

FIG. 7B is a schematic diagram of column determination provided in embodiments of the present disclosure;

FIG. 7C is a schematic diagram of grid determination provided in embodiments of the present disclosure;

FIG. 8 is a schematic block diagram of a direct memory access module provided in embodiments of the present disclosure; and

FIG. 9 is a schematic block diagram of an electronic device provided in embodiments of the present disclosure.

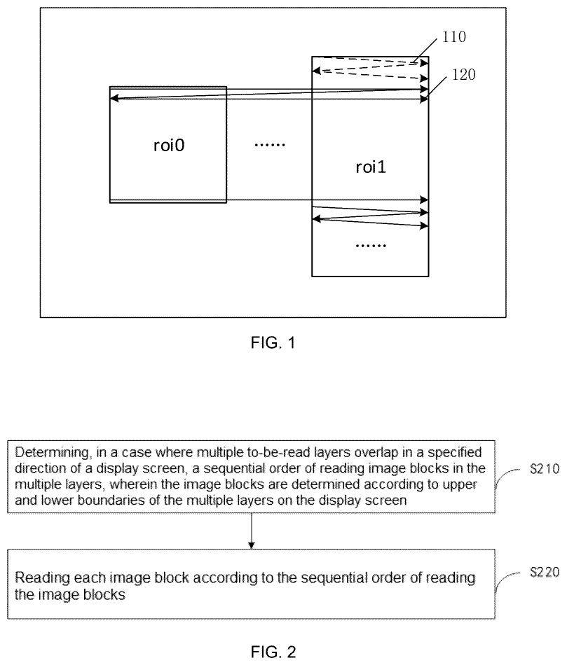

### DETAILED DESCRIPTION OF EMBODIMENTS

Hereinafter, embodiments of the present disclosure are described in detail with reference to drawings. It should be noted that, although the same elements are shown in different drawings, they will be denoted by the same reference numerals. In the following description, detailed configuration, specific details of components and the like are provided only to assist in comprehensively understanding embodiments of the present disclosure. Therefore, those skilled in the art should know that various changes and modifications could be made to the embodiments described herein without departing from the scope of the present disclosure. In addition, descriptions of well-known functions and constructions are omitted for clarity and conciseness. Terms described below are terms defined in consideration of functions in the present disclosure, and may differ according to users, user's intentions or habits. Therefore, definitions of the terms should be determined based on contents throughout the present description.

The present disclosure may have various modifications and various embodiments, and in the present disclosure, the embodiments are described in detail below with reference to the drawings. However, it should be understood that the present disclosure is not limited to the embodiments, but includes all modifications, equivalents and substitutes within the scope of the present disclosure.

The terms used herein are merely used to describe various embodiments of the present disclosure and are not intended to limit the present disclosure. Singular forms are intended to include plural forms, unless clearly indicated otherwise in the context. In the present disclosure, it should be understood that the term “including (comprising)” or “having” indicates presence of a feature, number, step, operation, structural element, component or combinations thereof, and does not exclude the possibility of presence of one or more other features, numbers, steps, operations, structural elements, components or combinations thereof, or addition of one or more other features, numbers, steps, operations, structural elements, components or combinations thereof.

Unless defined differently, all terms used herein have the same meaning as understood by those skilled in the art to which the present disclosure belongs. Unless clearly defined in the present disclosure, terms (such as terms defined in general dictionaries) should be construed to have the same meanings as those in the context of related art, and should not be interpreted as having idealized or over-formal meanings.

An electronic device according to an embodiment may be one of various types of electronic devices. The electronic device may include, for example, a portable communication device (for example, a smart phone), a computer, a portable multimedia device, a portable medical device, a camera, a wearable device or a household appliance. According to an embodiment of the present disclosure, the electronic device is not limited to those described above.

The terms used in the present disclosure are not intended to limit the present disclosure, but are intended to include various changes, equivalents or alternatives of corresponding embodiments. In the description of the drawings, like reference numerals may be used to denote like or related elements. Singular forms of nouns corresponding to items may include one or more things unless clearly indicated otherwise in the context. As used herein, phrases such as “A or B”, “at least one of A and B”, “at least one of A or B”, “A, B or C”, “at least one of A, B and C” and “at least one of A, B or C” each may include all possible combinations of items listed together in corresponding one of the phrases. As used herein, terms such as “1st”, “2nd”, “first” and “second” may be used to distinguish corresponding component from another component, but not to restrict the component in other aspects (for example, importance or order). It is intended that if, with or without the term “operably” or “communicatively”, an element (for example, a first element) is referred to as being “coupled with”, “coupled to”, “connected with” or “connected to” another element (for example, a second element), it indicates that this element may be coupled with the another element directly (for example, wiredly), wirelessly or via a third element.

As used herein, the term “module” may include units implemented by hardware, software or firmware, and may be used interchangeably with other terms (for example, “logic”, “logic block”, “component” and “circuit”). A module may be a single integrated component or a minimal unit or part thereof adapted to perform one or more functions. For example, according to an embodiment, the module may be implemented in the form of application specific integrated circuit (ASIC).

For ease of understanding, related terms and concepts involved in embodiments of the present disclosure are introduced first below.

DPU is an application specific processor responsible for image processing in an SOC system. DPU includes at least one IP core. The IP core is Intellectual Property core. A narrow concept of the IP core is a pre-designed circuit functional module used in ASIC or FPGA (Field Programmable Gate Array). In a broad sense, the IP core is an integrated circuit core with an Intellectual Property core.

DMA is a functional module, in the IP core of DPU, responsible for retrieving layers from a storage module such as Memory and DDR (Double Data Rate, Double Data Rate Synchronous Dynamic Random Access Memory).

Layer is a generic term of pipelines responsible for performing color gamut conversion on data in an early stage in DPU.

ROI (Region of Interest) is a certain region in a picture, or the whole picture, stored in a storage module.

DMA is responsible for reading ROI from DDR and displaying the ROI on the Layer. In the prior art, in the case that pictures displayed on a screen overlap in a Y direction, when taking data from a storage module, DMA must determine a sequential order of the displayed pictures on the screen, so as to decide an order of taking the data. DMA needs to judge each time sending a read address request. Presence of judgment logic makes DMA need to add an additional judgment circuit, and the DMA puts in a very large area and a lot of power. In addition, due to the time increased by the judgment logic, in order to ensure real-time display of pictures, the DMA may be restricted in the prior art to read only 1-2 complete pictures or 1-2 ROIs from the storage module and display the same on the Layer. In order to realize the display of multiple pictures, DPU often needs to increase the number of Layers, and sets one DMA for each Layer, which further increases design cost and power consumption of DPU.

Based on the above problems, the present disclosure provides a multi-layer reading method, a direct memory access module, a processor and a device, wherein a sequential order of reading image blocks is determined before reading, and the image blocks are directly read one by one according to the order of reading the image blocks, without judging layer boundaries in each time of reading, thus getting rid of the complex boundary judgment logic, reducing the steps in the reading, and improving the reading efficiency.

As shown in FIG. 2, FIG. 2 is a schematic flowchart of a multi-layer reading method provided in embodiments of the present disclosure. As shown in FIG. 2, the method includes steps S210 to S220.

S210, determining, in a case where multiple to-be-read layers overlap in a specified direction of a display screen, a sequential order of reading image blocks in the multiple layers, wherein the image blocks are determined according to upper and lower boundaries of the multiple layers on the display screen.

The layers refer to images to be read by the direct memory access module from the storage module, which may be a certain region in a picture or the whole picture stored in a storage unit, and after processing, the images are displayed on the display screen. In the above, the storage module may be a memory, a solid state memory, or the like.

Before reading the layers, the direct memory access module acquires a display state of the multiple layers on the display screen, and if the display state indicates that the multiple layers overlap in a specified direction of the display screen, the sequential order of reading the image blocks in the multiple layers is determined, wherein the image blocks are determined according to the upper and lower boundaries of the multiple layers on the display screen.

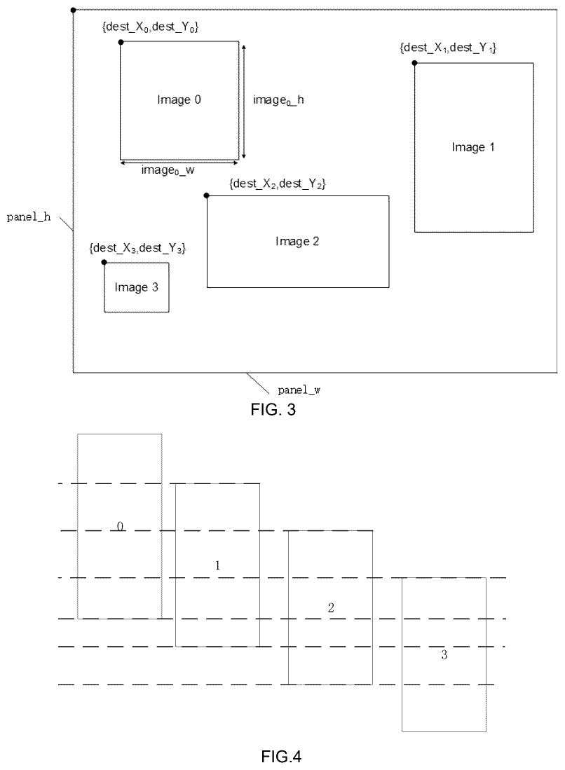

Exemplarily, as shown in FIG. 3, FIG. 3 is a schematic diagram of a display state of multiple layers shown in the present disclosure. Panel in FIG. 3 represents the display screen, and Panel includes two dimensions Panel-w and Panel-h, wherein Panel-w represents width, and Panel-h represents height. A point at an upper left corner of Panel is origin {0,0} of the screen. Panel has four layers: Image0, Imag1, Imag2, and Image3. Layout of the four layers on Panel is as shown in FIG. 3. Image0 is distributed at the upper left corner of Panel, Image1 is distributed at an upper right corner of Panel, Image2 is distributed in the middle of Panel, and Image3 is distributed at a lower left corner of Panel. Coordinates of an upper left corner of each layer are coordinates of the layer, for example, {dest_X0, dest_Y0} are coordinates of Image 0.

If a refreshing direction of pixel points in the display screen is from top to bottom and from left to right, for example, pixel rows are generated by refreshing them from top to bottom, and pixels in each row are refreshed from left to right. In order to provide data for refreshing of pixel point, the direct memory access module also should read image data (data of images) corresponding to the refreshing direction of the pixel points. That is to say, the direct memory access module will read each image data in accordance with the position of the image data in the display screen (from top to bottom and from left to right).

Exemplarily, in the display state as shown in FIG. 3, the direct memory access module will firstly read an image block on the Image0, and then read respective layers downwards. During the reading, there are layers overlapping in the Y direction (on the same row), for example, Image0 and Image1 overlap in the Y direction, and for overlapping regions of the two, the reading order of the direct memory access module in this case is as follows: firstly, reading the image block on the left, belonging to Image0, and then reading the image block on the right, belonging to Image1. In this case, by determining the reading order of different image data, the direct memory access module may directly read the image data of the layers, so as to avoid the need of boundary judgment when reading the data of the layers.

In the above example, the refreshing direction of the display screen, the overlapping of the multiple layers on the display screen and positions of the multiple layers on the display screen determine the sequential order of reading the image data.

FIG. 4 is a schematic diagram of the display state of multiple layers in another embodiment of the present disclosure. FIG. 4 is a schematic diagram of another display state of multiple layers shown in the present disclosure. FIG. 4 also includes the layers: Image0, Image1, Image2, and Image3. FIG. 4 shows a case where the four layers overlap the most in the Y direction, in this case, if the refreshing direction of the pixel points in the display screen is from left to right and from top to bottom, the direct memory access module may directly determine the reading order according to the positions of the layers on the display screen. A position on the display screen may be obtained through other information during the reading, without determining the reading order of different image data before reading.

In the embodiments of the present disclosure, shape and distribution of the layers may be diversified, and each layer also may be rotated or folded at various angles.

In some embodiments, overlapping in some directions does not affect the sequential order of reading the image data. For example, similarly when the refreshing direction of the pixel points is from top to bottom and from left to right, and the layers overlap only in an X direction and do not overlap in the Y direction, the direct memory access module may determine the reading order according to the positions of the layers on the display screen. The position on the display screen may be obtained through other information during the reading, and in this case, there is no need to determine the reading order of different image data before reading.

Therefore, a specified direction is preset in the present disclosure, wherein the specified direction is an overlapping direction affecting the reading order. Before reading the layers, the direct memory access module judges whether the multiple layers overlap in the specified direction of the display screen, and if overlapping, determines the sequential order of reading the image blocks in the multiple layers, and if not overlapping, directly reads the data of the multiple layers.

In some embodiments, the specified direction may be the Y direction of the display screen. In some other embodiments, the specified direction may be the X direction of the display screen.

In an embodiment of the present disclosure, the method further includes: acquiring storage information and display information of the multiple layers, wherein the storage information includes base addresses and data lengths of the layers, and the display information includes display positions and display directions; and determining whether the multiple layers overlap in the specified direction according to the storage information and the display information.

In the above embodiment, the storage information and the display information of the multiple layers may be acquired. The storage information includes the base addresses and data lengths of each layer. The base address is a relatively fixed memory address, a start address of data when loaded in the storage module such as a memory. It is an absolute address, representing a position of data in the storage module. The data length refers to a space occupied by data being stored in the storage module, such as one byte and 10 bits. The display information includes display positions and display directions of the layers, wherein the display position is the position of a layer on the display screen, and the display direction is a layout direction of pixel points in the layer on the display screen.

Whether the multiple layers overlap in the preset specified direction is judged through the storage information and the display information of the multiple layers. A size of each layer may be learnt through the storage information, and the display position and display direction of each layer on the display screen may be learnt through the display information, so that whether the multiple layers overlap in the preset specified direction may be judged.

In the above embodiment, whether the multiple layers overlap in the specified direction can be judged quickly and accurately through the storage information and the display information of the multiple layers.

In an embodiment of the present disclosure, the method further includes: simulating the display state of the multiple layers on the display screen; and simulating extension of the upper and lower boundaries of each layer in a target direction, to simulate segmentation of the multiple layers into multiple image blocks, wherein the target direction is a direction perpendicular to the specified direction. The above process does not really happen, and is only a simulation process, aiming at simulating segmentation of the multiple layers into multiple image blocks, so as to determine the sequential order of reading the image blocks.

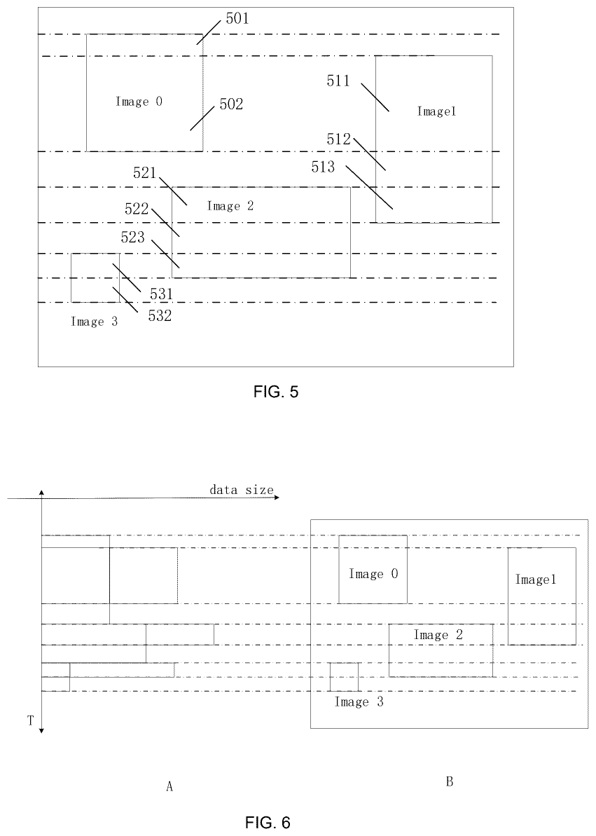

As shown in FIG. 5, FIG. 5 is a schematic diagram of an image block shown in the present disclosure. Information of each layer is read, for example, the storage information and the display information of the multiple layers are read, the state of the multiple layers on the display screen is simulated, and the upper boundary and the lower boundary of each layer in the target direction are simulated to be extended, wherein the target direction is a direction perpendicular to the specified direction (such as the Y direction, direction of column), and the target direction may be a direction of the row in FIG. 5. As shown in FIG. 5, the boundaries, i.e., upper and lower base boundaries, of the layers in the direction of row are simulated to be extended, and extension lines are as shown by dotted lines in FIG. 5. Each layer may be segmented into image blocks by extended boundaries, for example, Image0 in FIG. 5 is segmented into an image block 501 and an image block 502. Multiple image blocks are obtained after all the layers are segmented by the extension lines. In FIG. 5, Image1 is segmented into an image block 511, an image block 512 and an image block 513, Image2 is segmented into an image block 521, an image block 522 and an image block 523, and Image3 is segmented into an image block 531 and an image block 532.

In the above embodiment, by simulating the extension of the upper boundaries and the lower boundaries of the layers in the target direction, the image blocks, of the layers, overlapping in the target direction can be obtained simply and quickly.

In an embodiment of the present disclosure, determining the sequential order of reading the image blocks in the multiple layers includes: determining the sequential order of reading the image blocks according to positions of individual image blocks on the display screen and an overlapping relation in the specified direction.

As the refreshing direction of the display screen usually has been fixed when the direct memory access module reads data, the overlapping relation of the multiple layers on the display screen and the positions of the multiple layers on the display screen determine the sequential order of reading the image data. For example, in FIG. 5, according to the position of the display screen, the upper image block 501 needs to be read first, and then the lower image block 502 and image block 511 need to be read, wherein the image block 502 and the image block 511 have overlapping relation therebetween, and then the left image block 502 needs to be read first, and then the image block 511 is read.

In the above embodiment, through the positions of the image blocks on the display screen, and the overlapping relation in the specified direction, the sequential order of the direct memory access module reading the image blocks can be accurately determined.

In an embodiment of the present disclosure, the determining the sequential order of reading the image blocks according to positions of the image blocks on the display screen and overlapping relation in the specified direction includes: mapping each image block to a grid coordinate system according to the position of each image block on the display screen and the overlapping relation in the specified direction, wherein grid coordinate sizes in the grid coordinate system characterize the sequential order of reading the image blocks; calculating basic coordinates of each image block in the display screen; calculating the base address of each image block in the storage module according to the basic coordinates of each image block; and associating grids in the grid coordinate system with the base addresses of the image blocks so as to obtain grid distribution, wherein the grid distribution is used to determine the sequential order of reading the image blocks.

The sequential order of reading the image blocks may be expressed in the form of grids. For example, as shown in FIG. 6, FIG. 6 is a schematic diagram of image block ordering shown in the present disclosure. After the layers in image B of FIG. 6 are segmented into image blocks, cutting results thereof are aligned to the left so as to form image block regions independent of each other, wherein an alignment result is as shown in image A of FIG. 6. In image A, horizontal axis is for data size, and vertical axis is for time (T). The image blocks of the layers that should be read at different time may be judged through the vertical axis.

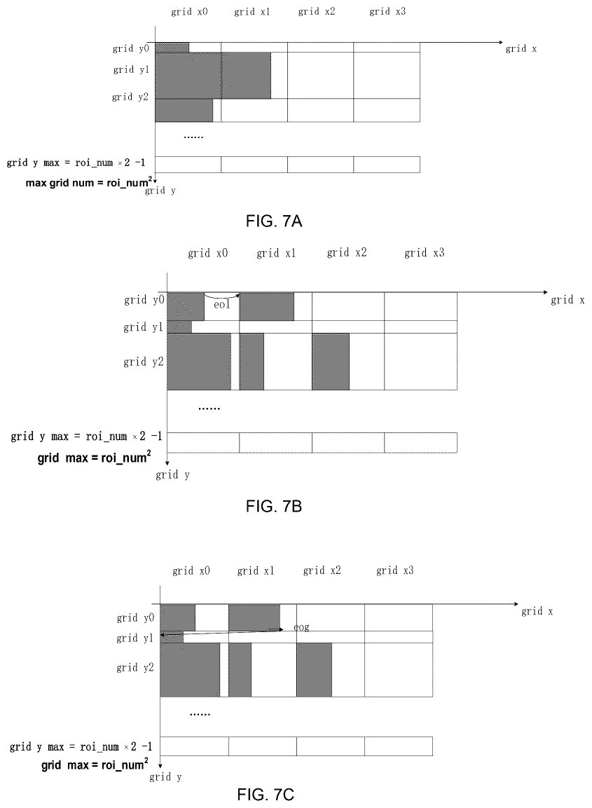

The grid coordinate system refers to grids established according to an overlapping situation of the layers in the specified direction. For example, as shown in FIG. 7A, FIG. 7A is a schematic diagram of a grid coordinate system shown in the present disclosure. Grid partitions are divided to include rows and columns. In FIG. 7A, grid y represents a row of the grid coordinate system, wherein grid y0 is a first row, followed by grid y1 and grid y2, and the number of rows generally depends on overlapping times of the layers on Y axis, and then grid y max=roi_num×2−1, that is, grid y max=2roi_num−1, where roi_num represents the number of layers or the number of regions of interest. In FIG. 7A, grid x represents a column of the grid coordinate system, wherein grid x0 is a first column, followed by grid x1 and grid x2. Each row includes a plurality of columns, the number of columns in each row in FIG. 7A depends on the number of layers, and the number of columns should be 4 when there are four layers. The worst case of four layers is that the four layers are cut into roi_num² roi partitions. A size of the grid coordinate system is defined such that a maximum coordinate in the y direction is roi_num×2−1, and a maximum coordinate in the x direction is roi_num.

All the image blocks are mapped to the grid coordinate system according to the positions of the image blocks on the display screen and the overlapping relation in the specified direction. For example, image A of FIG. 6 includes the positions of all the image blocks on the display screen and the overlapping relation in the specified direction. According to correspondence principle, one grid can correspond to only one image block, row sequence represents reading time, some grids in the same row overlap correspondingly in the Y direction. The image blocks are mapped one by one to the grid coordinate system, so as to obtain a result as shown in FIG. 7A. Dark parts in FIG. 7A indicate that the grids have corresponding image blocks, light parts indicate that the grids have no corresponding image blocks. The grid coordinate size in the grid coordinate system after the mapping characterizes the sequential order of reading the image blocks associated with the grids.

The basic coordinates of the image block on the display screen are acquired, for example, coordinates of four corners of the image block on the display screen. The base address of the image block is calculated according to the basic coordinates. For example, length and width of this image block may be calculated according to the coordinates of the corners, and a pixel area of this image block may be calculated according to the length and width. Data that can be stored in each storage unit in the storage module is fixed, for example, only data of 72 pixel points can be stored within 1 kb, then length of a storage address used by this image block is calculated according to a relation between pixel area and data storage, for example, if it is obtained by calculation through length and width that an image block includes 216 pixel points, it may be calculated that this image block uses a storage length of 3 kb. Further, the position of this image block in the whole layer Image0 may be calculated through the length and width, for example, it may be calculated through the length and width that the image block 501 starts from an upper left corner of Image0. If Image0 starts to be stored from the upper left corner, an initial storage address of Image0 is just initial storage address of the image block 501, all data 3 kb forward from this address is of the image block 501, and the initial storage address of Image0 is taken as the base address of the image block 501.

The base address of each image block is associated with the grid corresponding to this image block, so as to obtain the grid distribution, wherein the grid distribution can determine the sequential order of reading the image blocks.

S220, reading each image block according to the sequential order of reading the image blocks.

The image blocks are read in sequence according to the determined sequential order of reading the image blocks.

In the above multi-layer reading method, reading is performed according to the order of reading the image blocks, and the direct memory access module does not need to judge in each time of reading, thus getting rid of the complex boundary judgment logic, reducing the steps in the reading, and improving the reading efficiency.

In an embodiment of the present disclosure, the step of reading each image block according to the sequential order of reading the image blocks includes: sequentially selecting grid rows in the grid distribution in an ascending order of row values in the grid distribution, and reading image blocks corresponding to all grid columns in each selected grid row.

When the grid distribution is as shown in FIG. 7A, the direct memory access module may read data on the display screen from top to bottom in the ascending order of row values. Meanwhile, multiple columns in one row of grids (grid row) represent presence of multiple overlapping image blocks, and when reading data in the same row, the direct memory access module can directly read all data required for display in overlapping regions, without judging the boundary relation between the image blocks.

Therefore, the direct memory access module may sequentially select the grid rows in the grid distribution in the ascending order of row values in the grid distribution. With regard to one selected row, by acquiring addresses corresponding to all grid columns in this grid row, the addresses of the image blocks that overlap at the same height of the display screen may be read. Each grid column in a row corresponds to one independent image block, and then the image block of one layer may be read just by acquiring the base address corresponding to the grid.

In the above embodiment, the grid distribution indicates the sequential order of reading the image blocks, and the direct memory access module reads the data according to the grid distribution, to meet display requirements. Moreover, the grids in each row contain all image blocks overlapping in a specified region, and the direct memory access module does not need to jump or judge between different layers in the grids of the same row, thus improving the reading efficiency, and reducing the reading time.

In an embodiment of the present disclosure, the sequentially selecting the grid rows in the grid distribution in an ascending order of row values in the grid distribution and reading image blocks corresponding to all grid columns in each selected grid row includes: repeatedly executing a reading step until all image blocks corresponding to the grids in the grid distribution are read, wherein the reading step includes: acquiring a current count value of a counter; selecting one row of grids in the grid distribution according to the current count value, so as to obtain a current grid row; performing data reading according to all base addresses corresponding to individual columns of grids in the current grid row; and if the number of columns of the current grid row is equal to the number of layers, updating the count value of the counter, wherein the updated count value is used to determine a next grid row.

When the grid distribution is as shown in FIG. 7A, a method of reading the image blocks according to the grid distribution may include: repeatedly executing a reading step, and stopping the reading step when all image blocks recorded in the grid distribution is read. The reading step includes: acquiring a current count value of a counter. In the present disclosure, the counter is used to judge a currently read grid row, for example, an initial value of the counter is set to be 0.

A row of grids in the grid distribution are selected according to the current count value, and the selected grids are used as the current grid row. Exemplarily, if the current count value is 0, grid row grid y0 is selected, and grid y0 is taken as the current grid row.

Each column of grids in the current grid row are read grid by grid in an ascending order of column values. For a grid column, the base address corresponding to this column of grids is acquired, and data is read according to the base address. Exemplarily, in FIG. 7A, for grid y0, the base address corresponding to grid x0 column in this grid row is acquired first, so as to read image data.

The grid row represents a partition overlapping on the Y axis on the display screen, all data of this partition can be read through the base address of this grid row, and when reading each partition, address of each read request may be calculated with only one counter inside.

During the reading, positions of image blocks of a next layer may be obtained just through simple column determination (end of line, eol) in the same grid row. Exemplarily, as shown in FIG. 7B, FIG. 7B is a schematic diagram of column determination shown in the present disclosure. The column determination is performed after data corresponding to grid (grid x0, grid y0) is read in FIG. 7B, and when it is judged that the image block ends, the base address corresponding to the next grid is acquired, so as to read data of image blocks of another layer.

There may be varied methods of performing column determination. For example, pixel length of currently read image data may be calculated, and when the read pixel length is equal to width of the layer, it indicates that the reading of the image block ends. Alternatively, size of currently read data is calculated, and when the size of the read data is equal to a size of the image blocks in the grid, it indicates that the reading of the image blocks ends. The present disclosure does not restrict the methods for the column determination.

However, when next row needs to be read after the current grid y0 row has been read, logic is also quite simple, without complex boundary judgment, and only grid determination (end of grid, eog) needs to be executed. When it is determined that the grid row ends, an address that needs to be sent by the next grid row can be obtained by jumping. Exemplarily, as shown in FIG. 7C, FIG. 7C is a schematic diagram of grid determination shown in the present disclosure. After data corresponding to grid (grid x1, grid y0) is read in FIG. 7C, the grid determination is performed, and if it is determined that the grid row ends, it jump to next grid row grid y1. For example, the number of columns of the currently read columns in the grid row currently read is acquired, and if the number of columns in the current grid row is equal to the number of layers, the count value of the counter is updated, for example, the count value of the counter is increased by 1. The next grid row is determined using the updated count value.

In addition to the above grid determination through the number of columns, other grid determination methods also may be used in other embodiments of the present disclosure, for example, the size of data read by the grid row may be calculated, wherein if the size of the read data is equal to data size of overlapping image blocks, as shown in FIG. 7C, when the size of data read from the grid (grid x0, grid y0) and grid (grid x1, grid y0) is equal to data size of two image blocks, it is determined to jump from grid y0.

In the above embodiments, the layer reading performed through the grid distribution gets rid of the complex boundary determination logic, simplifies the address calculation, and simplifies the reading steps and circuit design, and addition of layers no longer causes exponential increase of logic complexity of circuit, which becomes linear increasing.

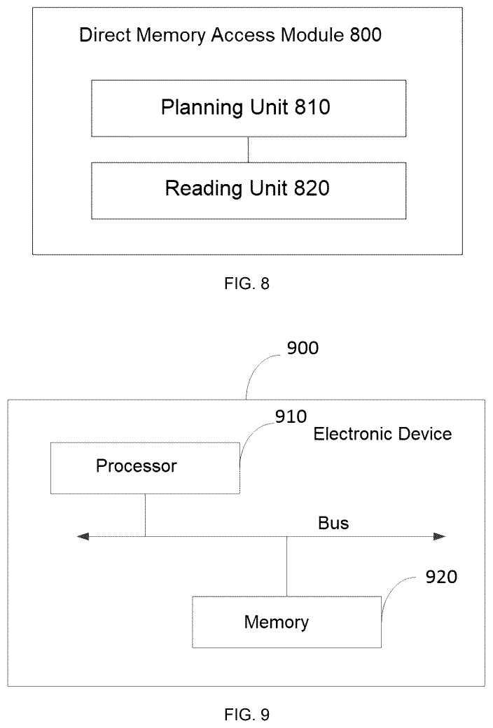

As shown in FIG. 8, FIG. 8 shows a direct memory access module 800 further provided in embodiments of the present disclosure. The direct memory access module 800 includes: a planning unit 810 and a reading unit 820.

The planning unit 810 is configured to determine, in a case where multiple to-be-read layers overlap in a specified direction of a display screen, a sequential order of reading image blocks in the multiple layers, wherein the image blocks are determined according to upper and lower boundaries of the multiple layers on the display screen.

The reading unit 820 is configured to read each of the image blocks according to the sequential order of reading the image blocks.

In an embodiment of the present disclosure, the planning unit 810 is further configured to: simulate a display state of the multiple layers on the display screen; and simulate extension of the upper and lower boundaries of each layer in a target direction, to simulate segmentation of the multiple layers into multiple image blocks, wherein the target direction is a direction perpendicular to the specified direction.

In an embodiment of the present disclosure, the planning unit 810 is specifically configured to: determine the sequential order of reading the image blocks according to positions of the image blocks on the display screen and an overlapping relation in the specified direction.

In an embodiment of the present disclosure, the planning unit 810 is specifically configured to: map each image block to a grid coordinate system according to the position of each image block on the display screen and the overlapping relation in the specified direction, wherein grid coordinate sizes in the grid coordinate system characterize the sequential order of reading the image blocks; calculate basic coordinates of each image block in the display screen; calculate base addresses of each image block in a storage module according to the basic coordinates of each image block; and associate grids in the grid coordinate system with the base addresses of the image blocks so as to obtain grid distribution, wherein the grid distribution is used to determine the sequential order of reading the image blocks.

In an embodiment of the present disclosure, the direct memory access module further includes a determination unit, wherein the determination unit is configured to acquire storage information and display information of the multiple layers, wherein the storage information includes the base addresses and data lengths of the layers, and the display information includes display positions and display directions; and determine whether the multiple layers overlap in the specified direction according to the storage information and the display information.

In an embodiment of the present disclosure, the reading unit 820 is specifically configured to sequentially select each grid row in the grid distribution in an ascending order of row values in the grid distribution, and read image blocks corresponding to all grid columns in each selected grid row.

In an embodiment of the present disclosure, the reading unit 820 is specifically configured to repeatedly executing the reading step, until all image blocks corresponding to individual grids in the grid distribution are read, wherein the reading step includes: acquiring a current count value of a counter; selecting one row of grids in the grid distribution according to the current count value, so as to obtain a current grid row; performing data reading according to the base addresses corresponding to individual columns of grids in the current grid row; and if the number of columns of the current grid row is equal to the number of layers, updating the count value of the counter, wherein the updated count value is used to determine a next grid row.

The implementation principle of the direct memory access module provided in the embodiments of the present disclosure and the technical effects produced thereby are the same as those in the preceding method embodiments. For the sake of concise description, reference may be made to corresponding contents in the preceding method embodiments for parts that are not mentioned in device embodiments.

Embodiments of the present disclosure further provide a display processor, wherein the display processor includes: a processing layer and the direct memory access module according to any one of the above embodiments, and wherein the processing layer is configured to receive and process data read by the direct memory access module.

Embodiments of the present disclosure further provide an electronic device, wherein the electronic device includes: a display screen and the display processor according to any one of the above embodiments, and wherein the display screen is connected to the display processor.

As shown in FIG. 9, FIG. 9 shows a schematic block diagram of an electronic device 900 provided in embodiments of the present disclosure. The electronic device 900 includes: a processor 910 and a memory 920.

The processor 910, the memory 920 and various elements are directly or indirectly electrically connected to each other, so as to implement transmission or interaction of data. For example, these elements may be electrically connected via one or more communication buses or signal lines. The memory 920 is configured to store computer programs, for example, a software function module as shown in FIG. 8, i.e., the direct memory access module 800. In the above, the direct memory access module 800 includes at least one software functional module that can be stored in the memory 920 in a form of software or firmware or solidified in an operating system (OS) of the electronic device 900. The processor 910 is configured to execute executable modules stored in the memory 920, such as the software functional module or computer programs included in the direct memory access module 800.

In the above, the memory 920 may be, but is not limited to, random access memory (RAM), read only memory (ROM), programmable read-only memory (PROM), erasable programmable read-only memory (EPROM), and electric erasable programmable read-only memory (EEPROM), etc.

The processor 910 may be an integrated circuit chip that can process signals. The above processor may be a universal processor, including central processing unit (CPU), network processor (NP), microprocessor and so on, and also may be digital signal processor (DSP), application specific integrated circuit (ASIC), field programmable gate array (FPGA) or other programmable logic devices, discrete gates, transistor logic devices, or discrete hardware components. The processor can realize or execute various methods, steps and logic block diagrams disclosed in the embodiments of the present disclosure. The processor 910 also may be any conventional processor or the like.

Embodiments of the present disclosure further provide a non-volatile computer-readable storage medium (hereinafter referred to as storage medium for short) that stores computer programs, wherein when the computer programs are run by a computer, such as the above electronic device 900, the above multi-layer reading method is executed.

It should be noted that various embodiments in the present description are described in a progressive manner, each embodiment focuses on differences from others, and references can be made between each other for the same or similar parts in various embodiments.

In several embodiments provided in the present disclosure, it should be understood that the apparatus and method disclosed also may be implemented by other methods. The apparatus embodiments described above are merely illustrative. For example, the flowcharts and block diagrams in the drawings show possible system structures, functions and operations of the apparatus, method and computer program product according to multiple embodiments of the present disclosure. In this regard, each block in the flowcharts or block diagrams may represent a part of one module, program segment or code, which contains one or more executable instructions used to achieve a specified logical function. It also should be noted that in some implementations as substitutions, the functions indicated in the blocks also may take effect in an order different from that marked in the drawings. For example, two continuous blocks may be executed substantially in parallel or in a reverse order, which depends on the function involved. It also should be noted that each block in the block diagrams and/or flowcharts or combination of the blocks in the block diagrams and/or flowcharts may be realized by an application specific hardware-based system for executing a specified function or action, or may be realized by a combination of application specific hardware and computer instructions.

Besides, functional modules in individual embodiments of the present disclosure may be integrated together to form one independent part, or each module may exist independently, or two or more modules are integrated to form an independent part.

If the function is realized in the form of a software functional module and is sold or used as an independent product, it may be stored in a computer-readable storage medium. Based on such understanding, the essential technical solution of the present disclosure, the part that contributes to the prior art, or part of the solution can be embodied in form of a software product. This computer software product is stored in a computer-readable storage medium and contains several instructions so as to enable one computer device (which may be a personal computer, a laptop, a server, an electronic device or the like) to execute all or part of the steps of the methods described in the embodiments of the present disclosure. The aforementioned computer-readable storage medium includes various media that may store program codes, such as USB flash disk, mobile hard disk, read-only memory (ROM), random access memory (RAM), diskette and compact disk.

The above are merely specific embodiments of the present disclosure, but the scope of protection of the present disclosure is not limited thereto, and any variation or substitution that may be easily conceived by those skilled in the art within the technical scope disclosed in the present disclosure should fall within the scope of protection of the present disclosure. Therefore, the scope of protection of the present disclosure should be determined by the scope of protection of the claims.

What is claimed is:

1. A multi-layer reading method, comprising:
determining, in a case where multiple to-be-read layers overlap in a specified direction of a display screen, a sequential order of reading image blocks in the multiple layers, wherein the image blocks are determined according to upper and lower boundaries of the multiple layers on the display screen; and
reading each image block according to the sequential order of reading the image blocks.

2. The method according to claim 1, further comprising:
acquiring storage information and display information of the multiple layers, wherein the storage information comprises base addresses and data lengths of the layers, and the display information comprises display positions and display directions; and
determining whether the multiple layers overlap in the specified direction according to the storage information and the display information.

3. The method according to claim 1, further comprising:
simulating a display state of the multiple layers on the display screen; and
simulating extension of the upper and lower boundaries of each layer in a target direction, to simulate segmentation of the multiple layers into multiple image blocks, wherein the target direction is a direction perpendicular to the specified direction.

4. The method according to claim 1, wherein the determining the sequential order of reading the image blocks in the multiple layers comprises:
determining the sequential order of reading the image blocks according to positions of the image blocks on the display screen and an overlapping relation in the specified direction.

5. The method according to claim 4, wherein the determining the sequential order of reading the image blocks according to positions of the image blocks on the display screen and an overlapping relation in the specified direction comprises:
mapping each image block to a grid coordinate system according to the position of the each image block on the display screen and the overlapping relation in the specified direction, wherein grid coordinate sizes in the grid coordinate system characterize the sequential order of reading the image blocks;
calculating basic coordinates of the each image block in the display screen;
calculating base addresses of the each image block in the storage module according to the basic coordinates of the each image block; and
associating grids in the grid coordinate system with the base addresses of the image blocks so as to obtain grid distribution, wherein the grid distribution is used to determine the sequential order of reading the image blocks.

6. The method according to claim 5, wherein the reading each image block according to the sequential order of reading the image blocks comprises:
sequentially selecting each grid row in the grid distribution in an ascending order of row values in the grid distribution, and reading image blocks corresponding to all grid columns in each selected grid row.

7. The method according to claim 6, wherein the sequentially selecting each grid row in the grid distribution in the ascending order of the row values in the grid distribution and reading the image blocks corresponding to all grid columns in the each selected grid row comprises:
repeatedly executing a reading step until all image blocks corresponding to individual grids in the grid distribution are read,
wherein the reading step comprises: acquiring a current count value of a counter; selecting one row of grids in the grid distribution according to the current count value, so as to obtain a current grid row; performing data reading according to the base addresses corresponding to each column of grids in the current grid row; and if number of columns of the current grid row is equal to number of the layers, updating a count value of the counter, wherein the updated count value is used to determine a next grid row.

8. A direct memory access module, comprising:
a planning unit, configured to determine, in a case where multiple to-be-read layers overlap in a specified direction of a display screen, a sequential order of reading image blocks in the multiple layers, wherein the image blocks are determined according to upper and lower boundaries of the multiple layers on the display screen; and
a reading unit, configured to read each of the image blocks according to the sequential order of reading the image blocks.

9. The direct memory access module according to claim 8, wherein the planning unit is further configured to:
simulate a display state of the multiple layers on the display screen; and
simulate extension of the upper and lower boundaries of each layer in a target direction, to simulate segmentation of the multiple layers into multiple image blocks, wherein the target direction is a direction perpendicular to the specified direction.

10. The direct memory access module according to claim 8, wherein the planning unit is configured to:
determine the sequential order of reading the image blocks according to positions of the image blocks on the display screen and an overlapping relation in the specified direction.

11. The direct memory access module according to claim 10, wherein the planning unit is configured to:
map each image block to a grid coordinate system according to the position of each image block on the display screen and the overlapping relation in the specified direction, wherein grid coordinate sizes in the grid coordinate system characterize the sequential order of reading the image blocks;
calculate basic coordinates of the each image block in the display screen;
calculate base addresses of the each image block in a storage module according to the basic coordinates of the each image block; and
associate grids in the grid coordinate system with the base addresses of the image blocks so as to obtain grid distribution, wherein the grid distribution is used to determine the sequential order of reading the image blocks.

12. An electronic device, wherein the electronic device comprises a memory and a processor,
the memory is configured to store computer programs, and the computer programs comprise program instructions; and
the processor is configured to call the computer programs, so as to implement the multi-layer reading method according to claim 1.

13. The method according to claim 2, wherein the determining the sequential order of reading the image blocks in the multiple layers comprises:
determining the sequential order of reading the image blocks according to positions of the image blocks on the display screen and an overlapping relation in the specified direction.

14. The method according to claim 13, wherein the determining the sequential order of reading the image blocks according to positions of the image blocks on the display screen and an overlapping relation in the specified direction comprises:
mapping each image block to a grid coordinate system according to the position of the each image block on the display screen and the overlapping relation in the specified direction, wherein grid coordinate sizes in the grid coordinate system characterize the sequential order of reading the image blocks;
calculating basic coordinates of the each image block in the display screen;
calculating base addresses of the each image block in the storage module according to the basic coordinates of the each image block; and
associating grids in the grid coordinate system with the base addresses of the image blocks so as to obtain grid distribution, wherein the grid distribution is used to determine the sequential order of reading the image blocks.

15. The method according to claim 14, wherein the reading each image block according to the sequential order of reading the image blocks comprises:
sequentially selecting each grid row in the grid distribution in an ascending order of row values in the grid distribution, and reading image blocks corresponding to all grid columns in each selected grid row.

16. The direct memory access module according to claim 8, further comprising a determination unit configured to:
acquire storage information and display information of the multiple layers, wherein the storage information comprises base addresses and data lengths of the layers, and the display information comprises display positions and display directions; and
determine whether the multiple layers overlap in the specified direction according to the storage information and the display information.

17. The direct memory access module according to claim 11, wherein the reading unit is configured to:
sequentially select each grid row in the grid distribution in an ascending order of row values in the grid distribution, and reading image blocks corresponding to all grid columns in each selected grid row.

18. The direct memory access module according to claim 17, wherein the reading unit is configured to:
repeatedly execute a reading step until all image blocks corresponding to individual grids in the grid distribution are read,
wherein the reading step comprises: acquiring a current count value of a counter; selecting one row of grids in the grid distribution according to the current count value, so as to obtain a current grid row; performing data reading according to the base addresses corresponding to each column of grids in the current grid row; and if number of columns of the current grid row is equal to number of the layers, updating a count value of the counter, wherein the updated count value is used to determine a next grid row.

19. The direct memory access module according to claim 16, wherein the planning unit is configured to:
determine the sequential order of reading the image blocks according to positions of the image blocks on the display screen and an overlapping relation in the specified direction.

20. The direct memory access module according to claim 19, wherein the planning unit is configured to:
map each image block to a grid coordinate system according to the position of each image block on the display screen and the overlapping relation in the specified direction, wherein grid coordinate sizes in the grid coordinate system characterize the sequential order of reading the image blocks;
calculate basic coordinates of the each image block in the display screen;
calculate base addresses of the each image block in a storage module according to the basic coordinates of the each image block; and
associate grids in the grid coordinate system with the base addresses of the image blocks so as to obtain grid distribution, wherein the grid distribution is used to determine the sequential order of reading the image blocks.
